(19) United States
(12) Patent Application Publication
(10) Pub. No.: US 2007/0156945 A1
(43) Pub. Date: Jul. 5, 2007

(54) Signal processing circuit

(76) Inventors: Yasuo Nakata, Osaka (JP); Naoyuki Kashii, Osaka (JP)

Correspondence Address: MCDERMOTT WILL & EMERY LLP, 600 13TH STREET, NW, WASHINGTON, DC, 20005-3096, US

(21) Appl. No.: 10/582,216

(22) PCT Filed: Dec. 6, 2004
(86) PCT No.: PCT/JP04/18145

§ 371 Date: Jun. 8, 2006

(30) Foreign Application Priority Data
Dec. 11, 2003 (JP) 2003-413664

(51) Int. Cl. G06F 3/06

(52) U.S. Cl. 711/4

(57) ABSTRACT

The read out data is written in into the buffer 10 and when it is judged as it is not a desired user block by the user block judging means 7, the address pointer is controlled to keep the original position in the buffer 10 by the address pointer generating means 8, thereby enabling to over-write the user data from the beginning of the written in link section data to abolish the link section data. Thereby, when the data which are written in by a hack light system is read out, unnecessary data at the link section would not be stored in the buffer 10, there is required no buffer space for storing the data at the link section, and it is not required to store the data that has discontinuity due to the data lacking in the buffer 10, and thus it is possible to provide such a signal processing circuit that can reduce burden to the system control means 11 and can shorten the access time to the data.

### TECHNICAL FIELD

The present invention relates to a signal processing circuit for reading out data which are written into plural packets which are obtained by dividing tracks on discs such as CD-ROM, CD-R, and CD-RW, and more particularly, to that which is provided a function of enhancing the efficiency at reading out data which is written in by a packet write system.

### BACKGROUND ART

Conventionally, there is an optical disc apparatus in which data is written in not continuously but by adopting a constant length packet write system when data is written in into discs such as CD-R, CD-RW (for example, patent reference No.1). In such a packet write system, user data is written in with divided into plural packets. In the respective packets, as linking blocks for connecting packets to each other, link blocks and run in blocks are provided before the user block, and run-out blocks are added at behind the user blocks.

Patent reference No.1: Japanese patent publication No. 7-141660

### DISCLOSURE OF THE INVENTION

### Problems to be Solved by the Invention

FIG. 16 is a block diagram illustrating a construction of an optical disc apparatus having a prior art signal processing apparatus.

In FIG. 16, numeral 1 denotes an optical disc in which information signal is recorded on spiral or concentric tracks. Numeral 2 denotes a rotation driving means for driving an optical disc 1. Numeral 3 denotes an optical pick-up which converges a light beam onto the information surface of the optical disc 1 and outputs various information by detecting its reflection light. Numeral 4 denotes an actuator control means for moving the optical pick-up 3 in the focusing direction and in the radius direction so as to read out the information on the optical disc 1. Numeral 5 denotes a signal control means for receiving the signal obtained from the optical disc 1 and takes out the signal for controlling the actuator and the information signal. Numeral 6 denotes a block ID detection means for detecting the block ID from the information signal obtained from the signal control means 5. Numeral 8a denotes an address pointer generating means for generating an address pointer.

In addition, numeral 9 denotes an R/W control means for controlling the writing in/reading out into/from the buffer 10 and numeral 11 denotes a system control means for instructing the reading out position to the actuator control means 4 as well as the writing in and/or reading out to the R/W control means 9.

The operation of the optical disc apparatus constructed above will be described with reference to FIGS. 11, 17.

FIG. 17 is a diagram for explaining a data format of the optical disc which is provided a prior art signal processing circuit, which particularly shows the data storage circumstances in the buffer 10 while reading out the data. Arrows shown in the figure present the positions of the address pointers (AP) which are obtained by the address pointer generating means 8a.

The data circumstances shown in FIG. 17(a) schematically shows the information signal which is written in onto a disc with respect to each block. As represented by the data circumstances shown in FIG. 17(a), it is supposed that two blocks as blocks at the link section for connection blocks (hereinafter referred as pink block 1 and link block 2, respectively) and two blocks as user blocks for packets (hereinafter referred to as user block 1 and user block 2, respectively) are continuously written in on the optical disc. Further, the packets and the connection blocks are alternatively arranged on a disc, like packet 1, connection block 1, packet 2, connection block 2, . . . .

The data circumstances shown in FIG. 17(b) is the data storing configuration in the buffer 10 after the reading out of the link block 1 which is a first block, is carried out. First of all, the system control section 11 instructs the R/W control section 9 to write in the data which is read out into the buffer 10. Further, the R/W control means 9 writes the data into the buffer 10 with referencing to the address pointer which is obtained by the address pointer generating means 8a.

As a result, as shown in the data circumstance shown in FIG. 17(b), the data of the link block 1 is read in into the buffer 10. Further, the address pointer is controlled to move to position by one block front by the address pointer generating means 8a.

The data circumstance in FIG. 17(c) is a data storing circumstance or the buffer 10 after the link block 1 which is a second block, is read out from the data storing configuration of the buffer 10 shown in FIG. 17(b). Similarly to the case where the link block 1 which is the first block is read out, the data of the link block 2 is written in into the buffer 10 with referring to the address pointer. Then, since the address pointer is at a position having moved, the link block 2 is written in into at next to the link block 1, as shown in FIG. 17(c). Further, the address pointer is further moved to a position further by one block front by the address pointer generating means 8a.

Further, the data circumstance shown in FIG. 17(d) is the data storing configuration in the buffer 10 after the reading out of the link block 1 which is a third block, is carried out. Similarly to the case where the link block 1 which is the first block is read out, the data of the link block 1 is written in into the buffer 10 with referring to the address, pointer. Then, since the address pointer is at a position having moved, the user block 1 is written in into next to the link block 2. Further, the address pointer is controlled to move to by one block front by the address pointer generating means 8a.

The data configuration in FIG. 17(e) is the data string configuration in the buffer 10 after the reading out of the user block 2 which is the fourth block, is carried out. Similar to the case where link block 1 which is the first block was read out, the data of the user block 1 is written in into the buffer 10 with referring to the address pointer. Then, since the address pointer is at a position having moved as shown in FIG. 17(e), the user block 2 is written in into next to the user block 1. Further, the address pointer is controlled to move to a position further by one block front by the address pointer generating means 8a.

The prior art signal processing circuit is constructed as above, and when the data disc into which data is written by the above-described packet write system is read out, the data of the link section which is added in a packet is also read out. Therefore, if all the data read out from the disc are intended to be stored in the buffer, it may be required to again extract the required user data section from the buffer, thereby resulting in complicated processing.

Further, taking in of the data of the link section which is useless has resulted in that a further larger buffer space is required.

As described above, the prior art device has the problems as described above, and it is requested that reproduction from a disc is carried out not by reading out the data at the link section which is added in the packet but by reading out only the user data section that is only required. Here, as another prior art, one in which reproduction of a disc is carried out not by reading out data at the link section but by reading out only the user data section that is required.

First of all, the data is read out by making the pick-up aligned at the top block of the user block in the packet. Next, when the top block of the link blocks in the connection block is detected, it is controlled such that the pick-up is once halted and the data is read out with the pick-up being again aligned on the top block of the user blocks in the next packet by the control circuit. In this way, the prior art signal processing circuit has been processing data with not reading out the connection block but reading out only the user blocks in the packet.

However, in the prior art signal processing circuit, there is a problem that since the pick-up is once halted when the link blocks are detected, a burden of the control circuit is heavy. Further, in the prior art signal processing circuit, the pick-up is once halted when the link blocks are detected, the pick-up is moved to the next user block and the pick-up is again driven from that position, the access time to the data is increased.

The present invention is directed to solving the above-described problems and has for its object to provide a signal processing apparatus which can store the user data section in the above-described constant length packet efficiently in a buffer as well as can store only the user data certainly even when the non-continuous data due to such as data failure is inputted, and further can shorten the access time to the data by reducing the burden to the control circuit.

### MEASURES TO SOLVE THE PROBLEMS

In order to solve the above-described problems, there is provided a signal processing circuit according to claim 1 of the preset invention which comprises: data reading out means for reading out data, that is recorded on a track formed on a disc, comprising user blocks in the packet and/or link blocks in the connection blocks; a buffer for successively storing the data which are read out; user block judging means for judging as to whether the read out data are desired user blocks or not; address pointer generating means for generating an address pointer on the basis of the judgment result from the user block judging means; system control means for controlling to maintain the position of the address pointer at a position in the buffer where the link block is written in prior and to overwrite the data which were read out this time onto the data of link block which are previously written in into the buffer by the address pointer generating means, when the read data is judged as not desired.

According to claim 2 of the present invention, there is provided a signal processing circuit as defined in claim 1, wherein there is provided block ID detecting means which detects the block ID while successively reading out the data.

According to claim 3 of the present invention, there is provided a signal processing circuit as defined in claim 2, wherein there is provided continuity judging means which defines continuity of blocks on the basis of the block ID.

According to claim 4 of the present invention, there is provided a signal processing circuit as defined in claim 2, wherein the user block judging means compares the link block ID under being read out and the top block ID, thereby to judge that the block under being read out is a link block until the top block ID of the user block is detected, or compares the user block under being read out and the top block ID of the link block, thereby to judge that the block under being read out is a user block until the top block ID of the link block is detected.

According to claim 5 of the present invention, there is provided a signal processing circuit as defined in claim 3, wherein the system control means conducts, when it is detected What the block ID is a link block ID in the same connection block or a top block of a desired user block ID when the discontinuity of the block ID is detected by the continuity judging means, a control such that a re-search of a block is not conducted but the reading out of the data conducted as it is.

According to claim 6 of the present invention, there is provided a signal processing circuit as defined in claim 5, wherein the system control means judges the direction of discontinuity of the block ID by comparing the block ID and the block ID immediately before that when the discontinuity of the block ID is detected by the discontinuity judging means, and it is controlled that when the position of the data reading out position has moved to the direction coming close to a desired user block, re-search of a block is not conducted, while when the reading out position of data has moved to the direction different from that coming close to the desired position, or when the block ID and the block ID are identical to each other, the re-search of the block is conducted.

According to claim 7 of the present invention, there is provided a signal processing circuit comprising: data reading out means for reading out data comprising user blocks in the packet and/or link blocks in the connection blocks; a buffer for successively storing data which are read out; user block judging means for judging as to whether the read out data are desired user blocks or not; and data control means for controlling so that the data is converted in its data format and is stored in the buffer.

According to claim 8 of the present invention, there is provided a signal processing circuit comprising: data reading out means for reading out data comprising user blocks in the packet and link blocks in the connection blocks, which are stored on tracks formed on an optical disc; a buffer for successively storing the data which are read out; user block judging means for judging as to whether the read out data are desired user blocks or not; data control means for controlling a distinction information with being added to the data is stored in the buffer, which distinction information which can distinguish whether the data read out as above is user block or a link block on the basis of the judgment result by the user block judging means.

### EFFECTS OF THE INVENTION

According to the signal processing circuit of claim 1 of the present invention, since it comprises data reading out means for reading out data comprising user blocks in the packet and/or link blocks in the connection blocks, a buffer for successively storing the data which are read out, user block judging means for judging as to whether the read out data are desired user blocks or not, address pointer generating means for generating an address pointer on the basis of the judgment result from the user block judging means, and system control means for controlling to maintain the position of the address pointer at a position in the buffer where the link block is written in prior and to overwrite the data which were read out this time onto the data of link block which are previously written in into the buffer, it is possible to surely avoid that unnecessary data at the link section should be stored in a buffer, and therefore, it is possible to reduce burdens to the control means as well as to shorten the access time to the data.

According to the signal processing circuit of claim 2 of the present invention, since in a signal processing circuit of claim 1 there is provided bock ID detecting means which detects the block ID while successively reading out the data, it is possible to conduct recovery processing even in a case where the data at the link section lacks in reading out data which comprises the user block in the packet which is recorded on a track recorded in a disc and the link block in the connection block is successively read out, and it is further possible to prevent lacking of user data block and store certainly the user data in the buffer.

According to the signal processing circuit of claim 3 of the present invention, since in the signal processing circuit of claim 2 there is provided continuity judging means which defines continuity of blocks on the basis of the block ID, even when there arises a lack in the blocks at the link section, the position of the user block may not erroneously be detected, and further it is possible to carry out a recovering processing when the desired user block cannot be reached, and it is possible to prevent lack of user block and certainly store the user data in the buffer.

According to the signal processing circuit of claim 4 of the present invention, since in the signal processing circuit of claim 2 the user block judging means compares the link block ID under being read out and the top block ID of the user block to judge that the block under being read out is a link block until the top block ID of the user block is detected, or compares the user block under being read out and the top block ID of the link block to judge that the block under being read out is a user block until the top block ID of the link block is detected, the circuit can be constructed by a simple circuit.

According to a signal processing circuit of claim 5 of the present invention, since the system control means conducts, when it is detected that the block ID is a link block ID in the same connection block or a top block of a desired user block ID when the discontinuity of the block ID is detected by the continuity judging means, a control such that a re-search of a block is not conducted but the reading out of the data conducted as it is, unnecessary search is generated even when failure or track jumping occurs in a link section, whereby it is possible to shorten the time for reaching the desired user block.

According to a signal processing circuit of claim 6 of the present invention, since in a signal processing circuit of claim 5 the system control means judges the direction of discontinuity of the block ID by comparing the block ID and the block ID immediately before that when the discontinuity of the block ID is detected by the discontinuity judging means, and conducts a control such that when the position of the data reading out position has moved to the direction coming close to a desired user block, re-search of a block is not conducted, and when the position of reading out the data has moved to the direction different from that coming close to the desired position, or when the block ID and the block ID immediate before the block ID are identical to each other; the re-search of the block is conducted, it is possible to shorten the time for reaching a desired user block because there is no re-search generated even when failure or track jumping is generated in the link section, as well as it is possible to avoid the situations such that the link sections are repeatedly traced.

According to a signal processing circuit of claim 7 of the present invention, since it comprises data reading out means for reading out data comprising user blocks in the packet and/or link blocks in the connection blocks, a buffer for successively storing data which are read out, user block judging means for judging as to whether the read out data are desired user blocks or not, and data control means for controlling so that the data is converted in its data format and is stored in the buffer, it is possible to easily judge only the required user data when outputting the data in the buffer.

According to a signal processing circuit of claim 8 of the present invention, since it comprises data reading out means for reading out data comprising user blocks in the packet and link blocks in the connection blocks, which are stored on tracks formed on an optical disc, a buffer for successively storing the data which are read out, user block judging means for judging as to whether the read out data are desired user blocks or not, and data control means for controlling a distinction information with being added to the data is stored in the buffer, which distinction information which can distinguish whether the data read out as above is user block or a link block on the basis of the judgment result by the user block judging means, it is possible to easily judge only the required user data when outputting the data in the buffer.

### BRIEF DESCRIPTION OF THE DRAWINGS

FIG. 1 is a diagram illustrating a construction of an optical disc apparatus having a signal processing circuit according to a first embodiment of the present invention.

FIG. 2 is a diagram illustrating a data format and a data storage state in a buffer in an optical disc device having a signal processing device of the first embodiment of the present invention, where (a) schematically shows the information signal on a disc, (b) shows the storage configuration in the buffer after the link block 1 is read out, (c) shows the data storage state in the buffer after the link block 2 is read out, (d) shows the data storage state in the buffer after the user data 1 is read out, and (e) shows the data storage state in the buffer after the user data 2 is read out.

FIG. 3 is a diagram illustrating a construction of an optical disc device having a signal processing circuit of the second embodiment of the present invention.

FIG. 4 is a diagram for exemplifying the data format and the data storing configuration in the buffer in the optical disc apparatus having the signal processing circuit of the second embodiment of the present invention, wherein (a) schematically shows the information signal on the disc, (b) shows the data storing state in the buffer when the reading out position of the other link block is changed while the link block is under being read out, and (c) shows the data storing state in the buffer in a case where user blocks lack or the reading out position is changed to other user blocks during reading out of blocks are carried out.

FIG. 5 is a schematic diagram showing an optical disc device having a signal processing circuit of the third embodiment of the invention.

FIG. 6 is a diagram schematically showing an optical disc device having a signal processing circuit of the third embodiment.

FIG. 6 is a diagram schematically illustrating an optical disc device having a signal processing circuit of the fourth embodiment.

FIG. is a diagram illustrating the data format and the data storing configuration in the optical disc apparatus having a signal processing circuit of the fourth embodiment, where (a) schematically shows the information signal on a disc, (b) shows the storage configuration in the buffer when the reading out is carried out with the link block 2 lacking, and (c) shows the data storage state in the buffer when the reading out is carried out with the link block 2 lacking.

FIG. 8 is a diagram schematically showing a construction of an optical disc apparatus having a signal processing circuit off the fifth embodiment.

FIG. 9 is a diagram illustrating a data format and a data storage state in a buffer in an optical disc device having a signal processing device of the fifth embodiment of the present invention, where (a) schematically shows the information signal on a disc, (b) shows the storage configuration in the buffer when the reading out is carried out with the link block 2 lacking, (c) shows the data storage state in the buffer when after the reading out of the link data 2 is carried out, it returned to the link block 1, and (d) shows the data storage configuration when the link block 1 is again read out after the link block 2 is read out.

FIG. 10 is a diagram illustrating a construction of an optical disc apparatus having a signal processing circuit of a sixth embodiment of the present invention.

FIG. 11 is a diagram illustrating data format in an optical disc apparatus having a signal processing device of the sixth embodiment, where (a) shows the data format of the data which was read out from the disc, and (b) shows the data format after the replacement into a distinction information is carried out.

FIG. 12 is a diagram illustrating a data storage state in a buffer in an optical disc device having a signal processing device of the sixth embodiment of the present invention, where (a) schematically shows the information signal on a disc, (b) shows the storage configuration in the buffer when the reading out of the link block 1 is carried out, (c) shows the data storage state in the buffer when after the reading out of the link data 2 is carried out, (d) shows the data storage configuration when the link block 1 is read out, and (e) shows the storage configuration in the buffer after the user block 1 is read out.

FIG. 13 is a diagram illustrating a construction of an optical disc apparatus having a signal processing circuit of the seventh embodiment of the present invention.

FIG. 14 is a diagram showing data format in an optical disc apparatus having a signal processing device of the seventh embodiment of the present invention, where (a) shows data format of the data which was read out from the disc, and (b) shows the data format after the distinction information is added.

FIG. 15 is a diagram illustrating the data storage configuration in the buffer in an optical disc device having a signal processing circuit, where (a) schematically shows the information signal on a disc, (b) shows the data storing state in the buffer after the user block 1 is read out, (c) shows the data storing state in the buffer after the link buffer 2 is read out, and (e) shows data storing state in the buffer after the user block 2 is read out.

FIG. 16 is a diagram illustrating a construction of the prior art optical disc apparatus having a signal processing circuit. FIG. 17 is a diagram showing the data storing state in the buffer in an optical disc apparatus having a signal processing circuit, where (a) schematically shows the information signal on a disc, (b) shores the data storing state in the buffer after reading out the link block 1, (c) shows the data storing state in the buffer after reading out the link block 2, (d) shows the data storing state in the buffer after reading out the user block 1, and (e) shows the data storing state after reading out the user block 2.

### DESCRIPTION OF REFERENCE NUMERALS

1 optical disc
2 rotation driving means
3 optical pick-up
4 actuator control means
5 signal control means
6 block ID detection means
7, 7a user block judging means
8, 8a address pointer generating means
9 R/W control means
10 buffer
11, 11a, 11b system control means
12 continuity judgment means
13, 13adata control means

### BEST MODE FOR CARRYING OUT THE INVENTION

Hereinafter, the embodiments of the present invention will bed with reference to the drawings.

### EMBODIMENT 1

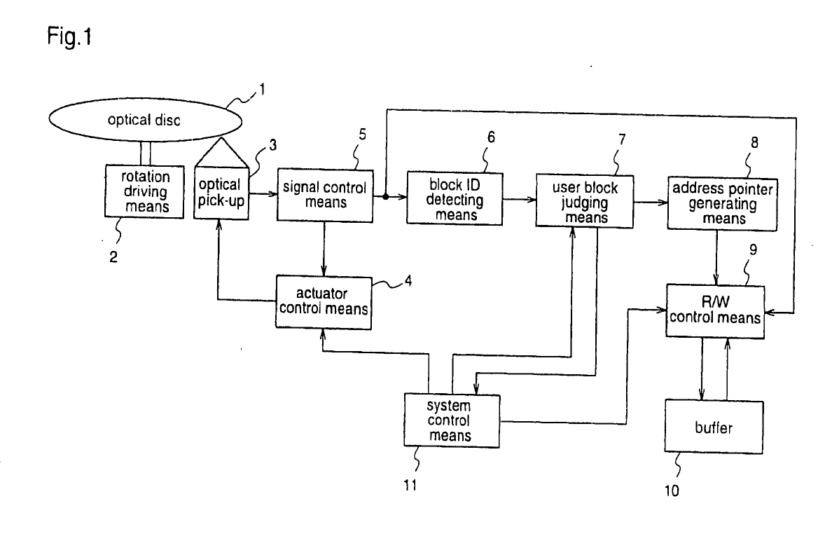

FIG. 1 is a diagram illustrating a block construction of an optical disc apparatus including a signal processing circuit according to a first embodiment of the present invention.

In FIG. 1, numeral 1 denotes an optical disc (recording medium) in which information signal is recorded on spiral or concentric tracks. Numeral 2 denotes a rotation driving means which rotates the optical disc 1. Numeral 3 denotes an optical pick-up which irradiates light beam onto the information surface of the optical disc 1 and detects its reflected light, to output various information. Numeral 4 denotes an actuator control means for moving the optical pick-up 3 in the focusing direction and in the radius direction so as to read out the information in the optical disc 1. Numeral 5 denotes a signal control means for receiving the signal obtained from the optical disc 1 and takes out the signal for controlling the actuator and the information signal. Numeral 6 denotes a block ID detecting means 6 for detecting the information from the block ID detecting means 6 and the block ID information corresponding to the user block. Numeral 8 denotes an address generating means for generating an address pointer from the information from the user block judging means 7.

Further, numeral 9 denotes an R/W control means for controlling the writing in or reading out in r from the buffer 10. Numeral 11 denotes a system control means which instructs the reading out position against the actuator control means 4 as well as instructs the user block ID against the actuator control means 4, and further instructs the writing in or reading out against the R/W control means 9.

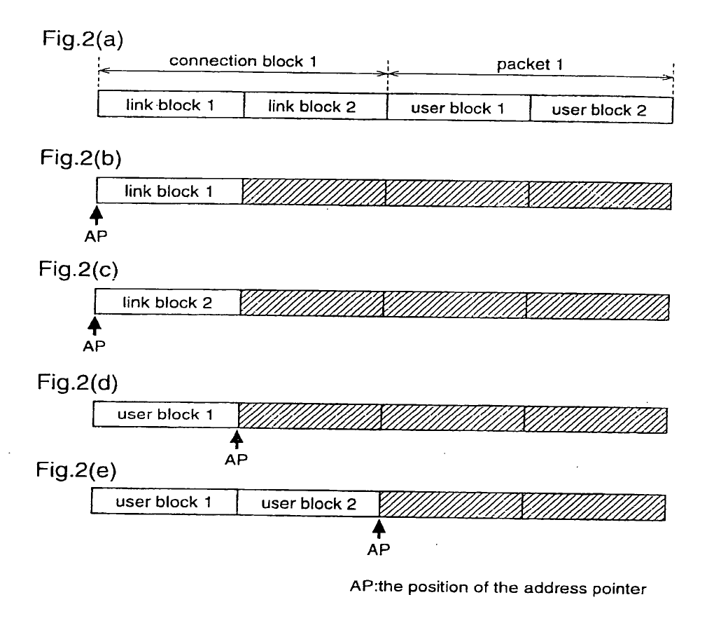

A description is given of an operation of an optical disc apparatus constructed as described above with reference to FIGS. 1 and 2.

FIG. 2 is a diagram illustrating the data format in an optical disc device provided with a signal processing circuit according to the first embodiment of the present invention, and shows the data storage configuration in the buffer 10 while reading out data. In addition, the arrow shown in the figure shows the position of the address pointer (AP) which is obtained by the address pointer generating means 8.

The data configuration shown in FIG. 2 (a) schematically shows the information signal which are written in onto a disc. It is supposed that on the disc, blocks at the link section are written in into the connection blocks by two blocks (hereinafter, referred as link block 1, and link block 2), and user blocks are written in into the packet by two blocks (hereinafter, referred to as user block 1, user block 2) continuously to each other as shown in the data configuration in FIG. 2(a). Further, the packets and the connection blocks are respectively alternatively constituted on a disc as packet 1, connection block 1, packet 2, connection block 2, . . . .

The data configuration shown in FIG. 2(b) is a data storing configuration after the link block 1 as the first block is read out. First of all, the user block judging information (herein, the user block 1, and user block 2) to be an objective is instructed to the user block judging means 7, and further, it is instructed to the R/W control means 9 to write the data read out to the buffer 10. Further, the R/W control means 9 writes data into the buffer 10 with referring to the address pointer that is obtained by the address pointer generating means 8. Besides, when plural user blocks are indicated by the user block judging information, it is possible to conduct a range designation such as from the top user block ID to the final user block ID.

As a result, as shown in the data configuration shown in FIG. 2(b), the data of link block 2 is written in into the buffer 10. Further, by the user block judging means 7, it is judged that the link block 1 does not correspond to the user block, and the address pointer is controlled to keep the original position in the buffer 10 by the address pointer generating means 8.

The data configuration shown in FIG. 2(c) is a data configuration of the buffer 10 after the link block 2 as a second block is read out, from the data configuration of the buffer 10 shown in FIG. 2(b). Similarly to the case where the link block 1 as the first block is read out, the data of the link block 2 is written in into the buffer 10 with referring to the address pointer. Since the address pointer is held as shown in FIG. 2(b), the overwriting onto the link block 1 is performed. Further, similarly to the case where the link block 1 is read out, it is judged that the link block 2 does not correspond to the user block by the user block judging means, and it is controlled that the address pointer keep the original position in the buffer 10 by the address pointer generating means.

Further, the data configuration shown in FIG. 2(d) is a data storage configuration in the buffer 10 after the user block 1 as the third block is read out. Similarly to the case where the link block 1 as a first block is read out, the data of the user block 1 as a first block is written in into the buffer 10 with referring to the address pointer. Then, since in the state of FIG. 2(c), the address pointer is held at the position where the link block 2 is written in at the former time, the user block 1 is over-written in into the link block 2. Further, it is judged that the user block 1 correspond to the user block, and the address pointer is controlled so as to move to a position one block prior by the address pointer generating means 8.

The data configuration shown in FIG. 2(e) is a data configuration in the buffer 10 after the user block 2 as a fourth block is read out. Similarly to the case where the link block 1 as a first block is read out, the data of the user block 1 is written in into the buffer 10 with referring to the address pointer. Since the address pointer is moved as shown in FIG. 2(d), the writing in is conducted at next to the user block 1. Then, it is judged that the user block 2 correspond to the user block by the user block generating means 7, and the address pointer is moved to the position one block away by the address pointer generating means 8.

As described above, according to the signal processing circuit according to the first embodiment of the present invention, user block judging means 7 and the address pointer generating means 8 are provided, and only when the data which is read out from the recording medium is judged as user block by the user block judging means 7, the data is recorded into a buffer 10 and the address pointer is moved to the next writing position, whereby only the user block can be stored in the buffer 10 efficiently.

Further, in this first embodiment, it is constructed such that the data is once written in into the buffer 10 irrespective of the link block or a user block, it is possible to shorten the access time to the data and further to reduce burdens to the control circuit.

### EMBODIMENT 2

Next, a signal processing circuit according to a second embodiment of the present invention will be described.

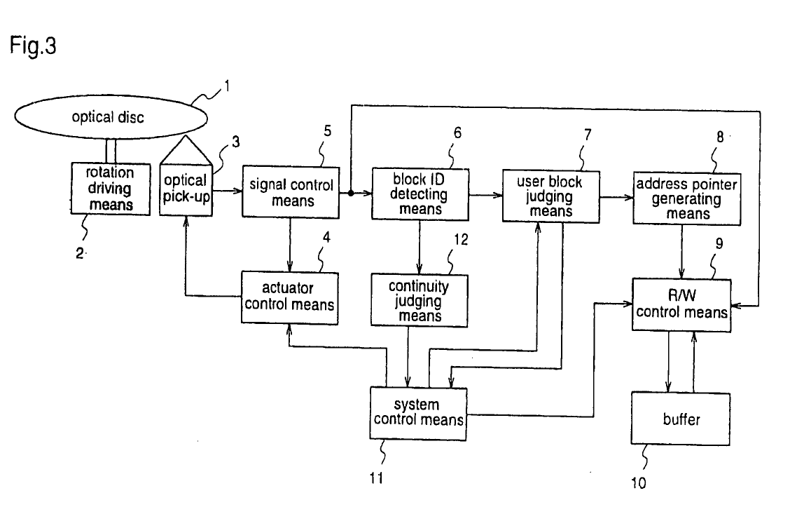

FIG. 3 is a diagram illustrating a block construction of an optical disc apparatus having a signal processing circuit according to the second embodiment of the present invention.

In FIG. 3, numeral 1 denotes an optical disc (recording medium) in which information signal is recorded on spiral or concentric tracks. Numeral 2 denotes a rotation driving means which rotates the optical disc 1. Numeral 3 denotes an optical pick-up which irradiates light beam onto the information surface of the optical disc 1 and detects its reflected light, to output various information. Numeral 4 denotes an actuator control means for moving the optical pick-up 3 in the focusing direction and in the radius direction so as to read out the information in the optical disc 1. Numeral 5 denotes a signal control means for receiving the signal obtained from the optical disc 1 and takes out the signal for controlling the actuator and the information signal. Numeral 6 denotes a block ID detecting means 6 for detecting the information from the block ID detecting means 6 and the block ID information corresponding to the user block. Numeral 8 denotes an address generating means for generating an address pointer from the information from the user block judging means 7.

Further, numeral 9 denotes an R/W control means for controlling the writing in or reading out in or from the buffer 10. Numeral 11 denotes a system control means which instructs the reading out position against the actuator control means 4 as well as instructs the user block ID against the actuator control means 4, and further instructs the writing in or reading out against the R/W control means 9. Numeral 12 denotes continuity judging means for judging as to whether the block ID information of the block ID detection means 6 has become a continuous value or not.

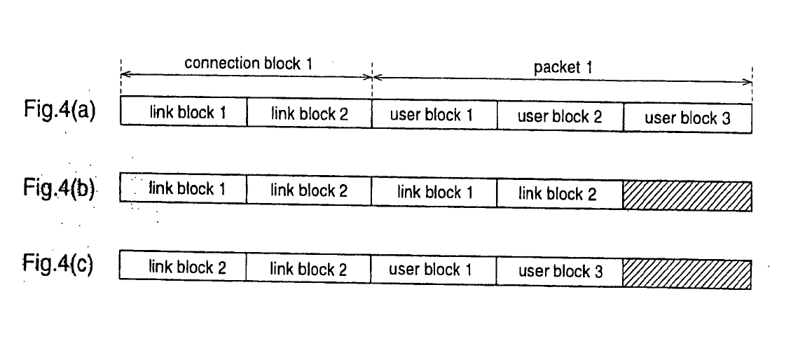

A description is given of the operation with reference to FIG. 3 and 4. Besides, it is supposed that the same reference numeral portions do the same operations as the first embodiment and a description is given here centered on the operation of the continuity judging means 12 which is newly provided.

FIG. 4 shows a data format of an optical disc that is provided with a signal processing circuit according to the second embodiment, and shows the flow of data in the normal state and abnormal state while reading in data.

The data configuration shown in FIG. 4(a) schematically shows the information signal which is written on a disc.

It is supposed that on the disc, blocks at the link section are written in into the connection blocks by two blocks (hereinafter, referred as link block 1, link block 2), and user blocks are written in into the packet by three blocks (hereinafter, referred to as user block 1, user block 2, user block 3) continuously to each other, as shown the data configuration in FIG. 4(a). Further, the packets and the connection blocks are respectively alternatively constituted on a disc as packet 1, connection block 1, packet 2, connection block 2, . . . .

The data configuration shown in FIG. 4(b) schematically shows the flow of the data for each block in a case where the reading out position is changed to another link block during reading out the link block. First of all, it is in a state that by that such as track jumping has occurred after the data of the link block 1 and the link block 2 are read out, the link block 1 is again read out, and thereafter, the link block 2 is further read out. In this way, in the state where the continuity of the block ID is not detected, if the link block is read out depicting a loop as described above, there may arise a phenomenon that it cannot reach the user block eternally.

Further, the data configuration shown in FIG. 4(c) schematically shows the flow of the data in a case where the user block has dropped out or the reading out position has moved to another position during reading out the user block. First of all, it is in a state where after the data of the link block 1 and the link block 2, and the user block 1 are read out, the user block 2 is not read out due to track jumping or data failure, and next the user block 3 is read out. In this way, when the continuity of the block ID is not detected, it cannot be judged as abnormality state even when data block lacking occurs during the desired user block being read out, and it may be possible that taking in of data into the buffer occurs in a state where a part of the desired user block is lacking.

In view of the above, the second embodiment of the present invention makes it possible to obtain the information for the system control means 11 to carry out a variety of recovery operations by detecting the continuity of the block ID by providing the continuity judging means 12. For example, by detecting the loop state of the link block or the lacking of the user block by the continuity judging means 12, it is possible to halt the writing in into the buffer 10 by the R/W control means 9 on the basis of the instruction from the system control means 11, or to again carry out the processing for changing the reading out position up to the top position of the desired block by the actuator control means 4 on the basis of the instruction from the system control means 11, thereby to store only the user block accurately into the buffer 10.

As described above, according to the signal processing circuit according to the second embodiment, the continuity judging means 12 is provided so as to enable detecting the continuity of the block ID which is detected by the block ID detecting means 6, and when it is judged that the continuity of the block ID is lost, it is possible to halt the writing in into the buffer or carry out the processing for again changing the reading out position up to the top position of the desired block (hereinafter referred to as re-search), after detecting that the looping state of the link block or the lacking of the user data is generated, and therefore, it is possible to store only the user block accurately into the buffer 10.

### EMBODIMENT 3

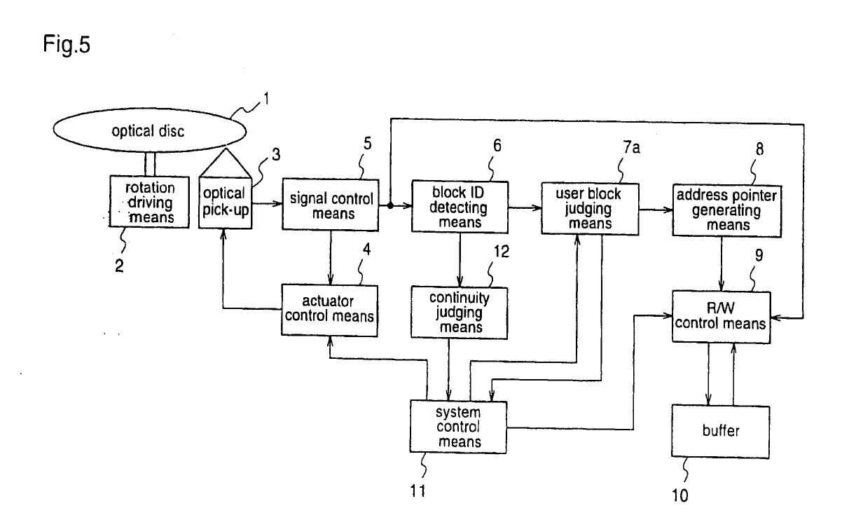

Next, a signal processing circuit according to a third embodiment of the present invention will be described. This third embodiment is characterized in that in the signal processing circuit of the second embodiment, in place of the user block judging means 7 as a part of the signal processing circuit, user block judging means 7a which carries out judgment using a new judgment system which is different from that in the second embodiment, as shown in FIG. 5.

A description is given of the operation. Since the basic operation is similar to that in the second embodiment, a description is given here centered on the operation of the user block judging means 7a.

As the user block judging means, it is possible to judge as to whether it is a user block or not, by providing plural comparator circuits to the number of the user block IDs of a desired packet. Further, it is also possible to judge the packets in the range from the top user block ID to the final user block ID as user blocks (or user block packets) by rising that the user blocks are arranged continuously as described above. However, providing the above construction will increase the circuit. Therefore, in this third embodiment, the user block judging means 7a is constituted by only comparator circuits.

First of all, while the link blocks are read out, the top block ID of the user block in the desired packet is set in the user block judging means 7a. In the user block judging means 7a, the top block ID of the user block and the link block ID which is under being read out now are compared by the comparator and up to the top block ID of the user block is detected, it is possible to judge that the block which is under being read out at present is a link block.

Next, while the user blocks are under being read out, the top block ID of the link block in the connection block which is to be reached next (which link block is a block positioned next to the final user block in a desired packet) set in the user block judging means 7a. Similarly as in reading link blocks, the top block ID of the link block which is to be reached next and the user block which is under being read out at present are compared and until the top block ID of the link block is detected, it can be judged that the block which is now under being read out is a user block by the user block judging means 7a. Or, since the continuity of the block ID can be detected by the continuity judging means 12, it can be judged that the block which is now under being read out is a user block until the continuity of blocks is broken.

Here, in the continuity judging means 12, when it is detected that the continuity of blocks is broken, it is possible to prevent from unnecessary data being stored in the buffer 10 by halting the writing operation into the buffer 10 by the R/W control means 9 on the basis of the instruction from the system control means 11, and carrying out the processing for changing the reading out position to a desired user block (re-search) by the actuator control means 4 on the basis of the instruction from the system control means 11.

As described above, according to the third embodiment, a comparator is employed as the user block judging means 7a, and the top user block ID in the packet which is to be detected next to the link block which is now under being read out, or the top link block ID in the connection block which is to be detected next to the user block which is now under being read out is set in the comparator, and the detection of the link block or the user block is carried out in the user block judging means 7awith confirming the continuity of blocks by the continuity judging means 12, whereby it is possible to accomplish the user block judgment by a simple construction.

### EMBODIMENT 4

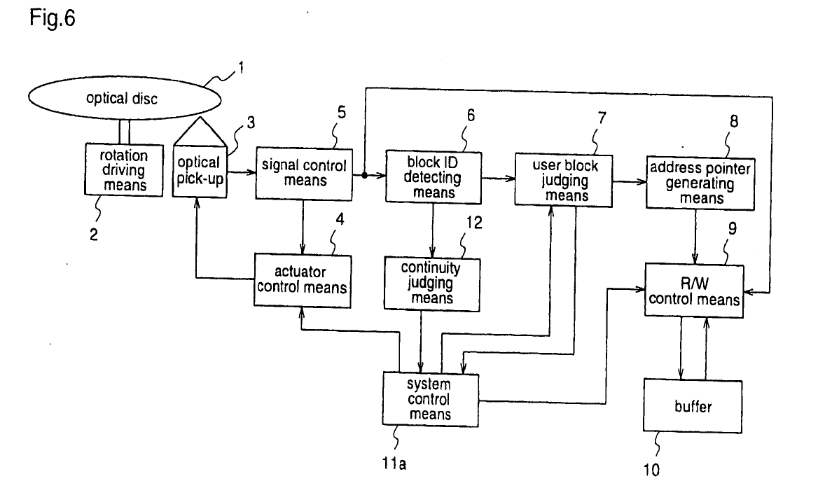

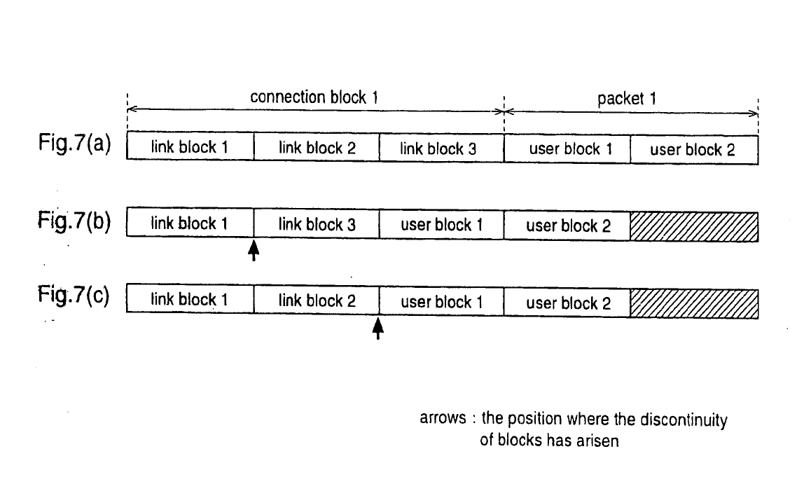

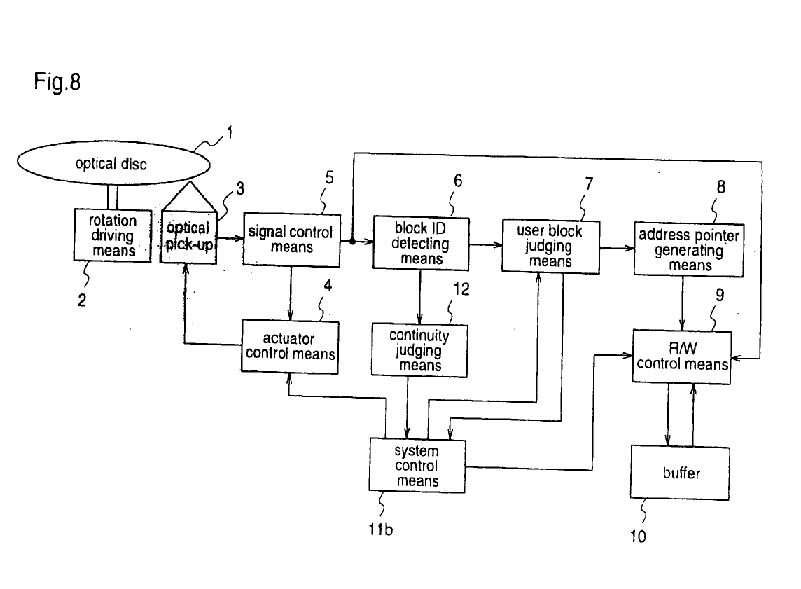

Next, a signal processing circuit according to a fourth embodiment of the present invention will be described. This fourth embodiment is characterized in that in the signal processing circuit of the second embodiment, in place of the system control means 11 as a part of the signal processing circuit, system control means 11a which carries out a control using a new control system which is different from that in the second embodiment, as shown in FIG. 6.

A description is given of the operation. Since the basic operation is similar to that in the second embodiment, a description is given here centered on the operation of the system control means 11a.

As described above, the continuity judging means 12 detects the continuity of the block ID and further the user block judging means 7 detects whether the detected block is a user block or not. In the above-described second or third embodiment, irrespective of that it is a link block or a user block, at the timing when the continuity of blocks is broken, the re-search is carried out. Here, FIG. 7 is a diagram illustrating the operation of the signal processing circuit of the fourth embodiment, and shows the flow of the data in the normal state and the abnormal state while reading out data.

In addition, the arrows shown in FIG. 7 show portions where the discontinuity of blocks has arisen due to the lacking in the data blocks or track jumping.

The data configuration in FIG. 7(a) schematically shows the information signal which is written on a disc for each block. It is supposed that on the disc, blocks at the link section are written in into the connection blocks by three blocks (hereinafter, referred as link block 1, link block 2, link block 3), and user blocks are written in into the packet by two blocks (hereinafter, referred to as user block 1, user block 2) continuously to each other, as shown in the data configuration in FIG. 7(a). Further, the packets and the connection blocks are respectively alternatively constituted on a disc as packet 1, connection block 1, packet 2, connection block 2, . . . .

The data configuration shown in FIG. 7(b) is a configuration after the reading out is carried out with the link block 2 lacking. The continuity judging means 12 detects the discontinuity from that the link block 3 is read out next to the link block 1, and the user block judging means 7 detects that it is not the user block. Here, the system control means 11a conducts a control such that no re-search is carried out when the discontinuity has occurred in the same connection block on the basis of the judgment result by the use block judging means 7.

Further, the data configuration shown in FIG. 7(c) shows a state after the reading out is carried out with the link block 3 lacking. The continuity judging means 12 detects the discontinuity from that the link block 1 is read out next to the link block 2, and the user block judging means 7 detects that it is at the top of the user block. Here, the system control means 11a controls not to conduct a re-search when the reading out position has moved toward the top of a desired user block on the basis of the judgment result by the user block judging means 7. Of course, when the reading out position has moved to the other user block (such as the second user block or the follower), the system control means 11a conducts such a control that a re-search is carried out to return the treading out position.

As described above, according to the fourth embodiment, a control by the system control means 11a is carried out so that not a re-search is carried out but the reading out as it is, is carried out when the movement of the reading out position in the same connection blocks or the movement of the reading out position to the top position of a desired user block is detected by the user block judging means 7 in a case where it is detected that the continuity of blocks is broken by the continuity judging means 12. Thereby, un-required re-search is not generated, and it is possible to shorten the time for reaching a desired user block.

### EMBODIMENT 5

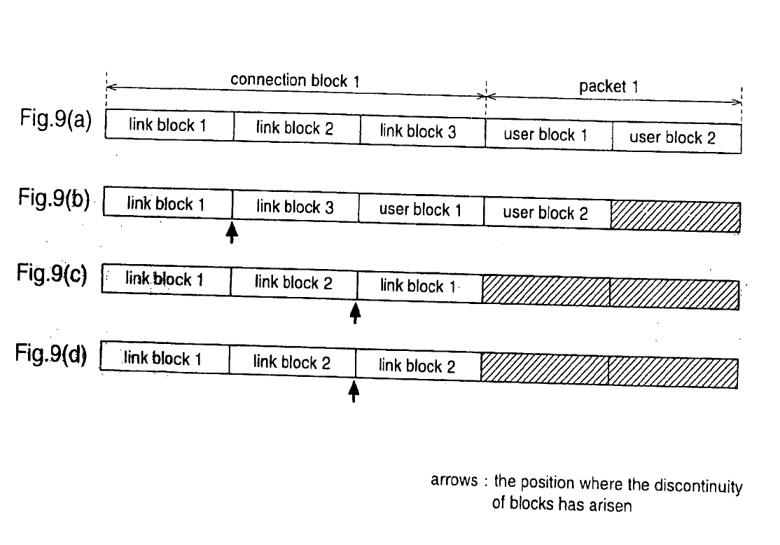

Next, a signal processing circuit according to a fifth embodiment of the present invention will be described. This fifth embodiment is characterized in that in the signal processing circuit of the fourth embodiment, in place of the system control means 11 as a part of the signal processing circuit, system control means 11b which carries out a control using a new control system which is different from that in the fourth embodiment, as shown in FIG. 9.

A description is given of the operation. Since the basic operation is similar to that in the fourth embodiment, a description is given here centered on the operation of the system control means 11b.

As described above, in the fourth embodiment, by that not a re-search is carried out but the reading out as it is, is carried out when the movement of the reading out position in the same connection blocks or the movement of the reading out position to the top position of a desired user block is detected even in a case where it is detected that the continuity of blocks is broken, thereby unnecessary re-search is not generated, and it is possible to shorten the time for reaching a desired user block. However, in such fourth embodiment, since when the movement of the reading out position in the blocks of the same link sections, a re-search is not conducted and the reading out as it is conducted, there may be a possibility that the blocks in the link sections are repeatedly read out.

Here, FIG. 9 is a diagram illustrating an operation of a signal processing circuit according to a fifth embodiment of the present invention, and shows the flow of the data in normal state and abnormal state while reading out the data.

Further, the arrows shown in FIG. 9 show portions where the discontinuity of blocks has arisen due to the lacking in the data blocks or track jumping.

The data configuration in FIG. 9(a) is that in which as the information signal which is written on a disc, blocks at the link section are written in into the connection blocks by three blocks (hereinafter, referred as link block 1, link block 2, link block 3), and user blocks are written in into the packet by two blocks (hereinafter, referred to as user block 1, user block 2) continuously to each other. Further, the packets and the connection blocks are respectively alternatively constituted on a disc as packet 1, connection block 1, packet 2, connection block 2, . . . .

The data configuration shown in FIG. 9(b) is a configuration after the reading out is carried out with the link block 2 lacking The continuity judging means 12 detects the discontinuity from that the link block 3 is read out next to the link block 1 as well as detects that the discontinuity is one in the direction coming close-to the desired user block, and the user block judging means 7 detects that it is not the user block. Here, the system control means 11b conducts a control such that no re-search is carried out when the discontinuity has occurred in the same connection block and the reading out position is moved toward the direction coming close to the user block.

Further, the data configuration shown in FIG. 9(c) shows a state where after the reading out of the link block 2 is carried, it has returned to the link block 1. The continuity judging means 12 detects the discontinuity from that the link block 1 is read out next to the link block 2 as well as detects that the discontinuity is one in the direction going further from the desired user block, and the user block judging means 7 detects that it is not the user block. Here, the system control means 11b controls to conduct a re-search when the reading out position has moved to the direction going further apart from the user block even when the discontinuity has occurred in the same connection block on the basis of the judgment result by the user block judging means 7.

Further, the data configuration shown in FIG. 9(d) is a configuration in which after the reading out of the link block 2 is carried out, the reading out of the link block 2 is carried out. Similarly to the configuration shown in FIG. 9(c), the continuity judging means 12 detects the discontinuity from that the link block 1 is read out next to the link block 2 as well as detects that the discontinuity is one in the direction going further from the desired user block, and the user block judging means 7 detects that it is not the user block. Here, the system control means 11b controls to conduct a re-search when the reading out position has moved to the direction going further apart from the user block even when the discontinuity has occurred in the same connection block on the basis of the judgment result by the user block judging means 7.

As described above, according to the signal processing circuit according to the fifth embodiment, when discontinuity of data is detected by the continuity judging means 12, that it is not a user block is detected by the user block judging means 7, and further that the moving direction of the reading out position is in the direction coming close to the user block, the system control means 11b carries out a control not to carry out a re-search while when the discontinuity is detected by the discontinuity judging means 12 and it is judged that it is not the user block by the user block judging means 7, and further the moving direction of the reading out position is in the direction going further apart from the user block, the system control means 11b carries out a control to conduct a re-search, whereby even when the reading out position has further moved to front with relative to a desired user block when such as lacking or track jumping has occurred in the link section, unnecessary re-search would not arise and it is possible to shorten the time for reaching a desired user block, and further it is possible to avoid such a situation that the link sections are repeatedly traced.

### EMBODIMENT 6

Next, a signal processing circuit according to a sixth embodiment of the present invention will be described.

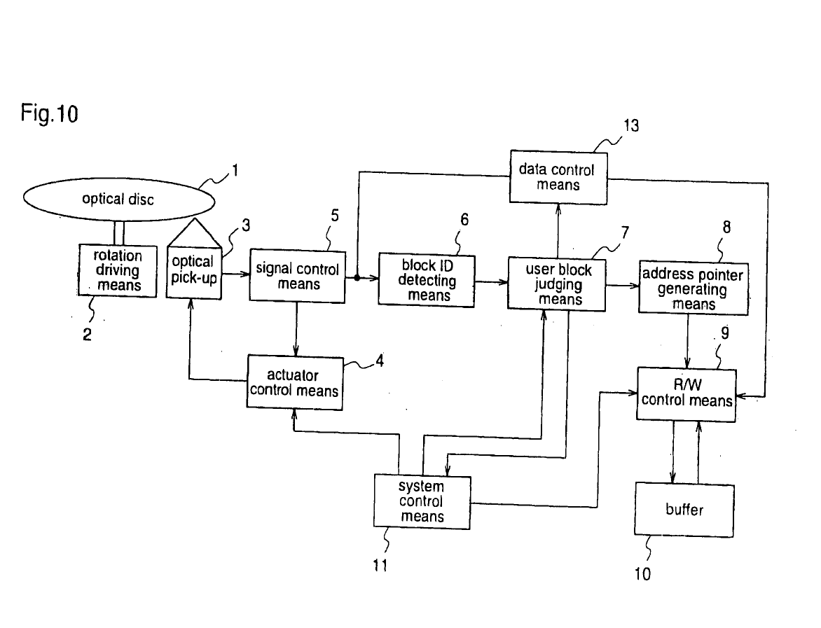

FIG. 10 is a diagram illustrating a block construction of an optical disc apparatus having a signal processing circuit according to the sixth embodiment of the present invention.

In FIG. 10, numeral 1 denotes an optical disc (recording medium) in which information signal is recorded on spiral or concentric tracks. Numeral 2 denotes a rotation driving means which rotates the optical disc 1. Numeral 3 denotes an optical pick-up which irradiates light beam onto the information surface of the optical disc 1 and detects its reflected light, to output various information. Numeral 4 denotes an actuator control means for moving the optical pick-up 3 in the focusing direction and in the radius direction so as to read out the information in the optical disc 1. Numeral 5 denotes a signal control means for receiving the signal obtained from the optical disc 1 and takes out the signal for controlling the actuator and the information signal. Numeral 6 denotes a means for detecting the block ID from the information signal that is obtained from the signal control means. Numeral 7 denotes user block judging means for carrying out user block judgment from the information from the block ID detection means 6 and the block ID information corresponding to the user block. Numeral 8 denotes an address generating means for generating an address pointer to the buffer 10.

Further, numeral 9 denotes an R/W control means for controlling the writing in or reading out in or from the buffer 10. Numeral 11 denotes a system control means which instructs the reading out position against the actuator control means 4 as well as instructs the user block ID against the user block judging means 7, and further instructs the writing in or reading out to the R/W control means 9.

Further, numeral 13 denotes data control means for replacing the data to be stored in the receiving buffer 10 from the signal control means 5 by a distinction information on the basis of the judgment result by the user block judging means 7.

An operation of the optical disc apparatus constituted as above will described with referring to FIGS. 10, 11, and 12.

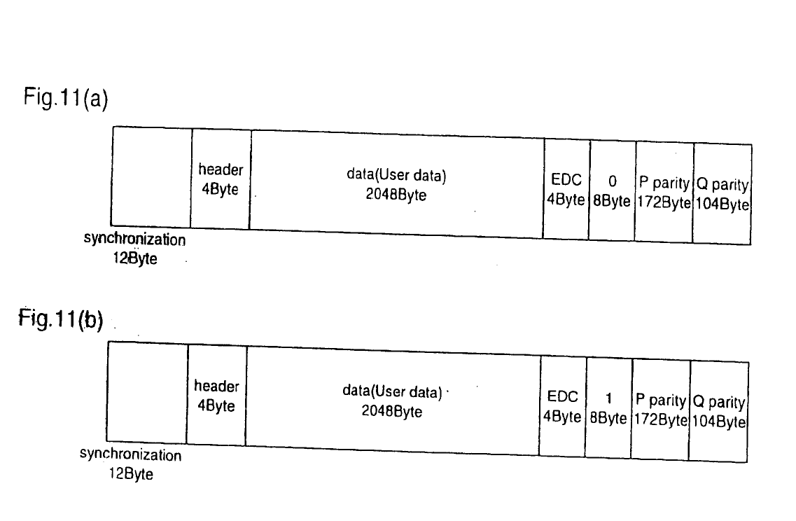

FIG. 11 shows a data format of an optical disc provided with a signal processing circuit according to a sixth embodiment of the present invention, and shows a format of one sub-coding frame in mode 1 of a CD-ROM. FIG. 11(a) shows a data format which was read out from disc 1, and FIG. 11(b) shows a data format after it is controlled such that 8 bytes in which 0 data in the Auxiliary data is stored is replaced by a distinction information by the data control means 13.

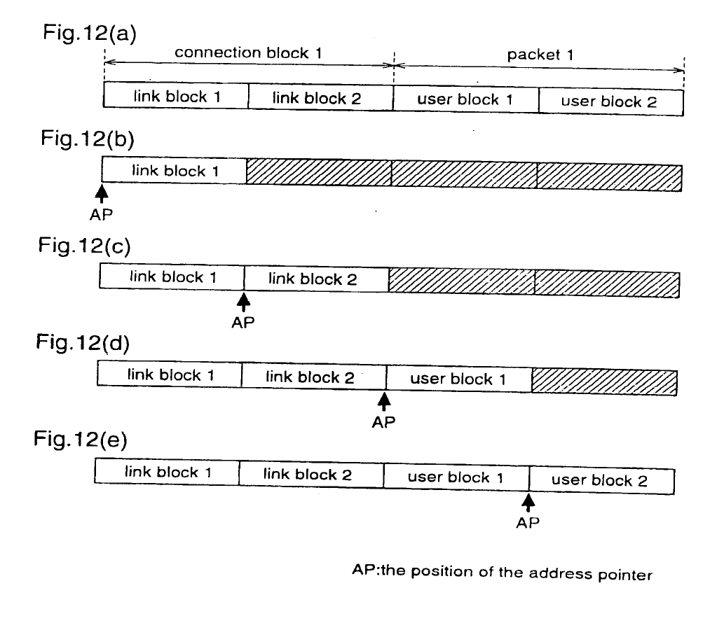

FIG. 12 shows a data format in an optical disc provided with a signal processing circuit according to the sixth embodiment of the present invention. Further, the arrows shown in the figure show the position (AP) of the address pointer which is obtained by the address pointer generating means 8 (AP).

The data configuration in FIG. 12(a) schematically shows the information signal which is written on a disc 1 for each block. It is supposed that on the disc 1, blocks at the link section are written in into the connection blocks by two blocks (hereinafter, referred as link block 1, link block 2), and user blocks are written in into the packet by two blocks (hereinafter, referred to as user block 1, user block 2) continuously to each other, as shown in the data configuration in FIG. 12(a). Further, the packets and the connection blocks are respectively alternatively constituted on a disc as packet 1, connection block 1, packet 2, connection block 2, . . . .

The data configuration shown in FIG. 12(b) is the data storing configuration in the buffer 10 after the reading out of the link block 1 as a first block is carried out. First of all, the user block judging information (herein, the user block 1, and user block 2) to be an objective is instructed to the user block judging means 7 by the system control means 11, and further, it is instructed to the R/W control means 9 to write the read out data into-the buffer 10. Meanwhile, the data control means 13 rewrites the link block 1 from the format shown in FIG. 11(a) to the format shown in FIG. 11(b) on the basis of the judgment result that is obtained by the user block judging means 7 that the link block 1 is a link block. Further, the R/W control means 9 writes data into the buffer 10 with referring to the address pointer that is obtained by the address pointer generating means 8.

As a result, the data of link buffer 1 is written in into the buffer 10, as shown in the-data configuration in FIG. 12(b). Further, the data which is replaced into the format shown in FIG. 11(b) is stored in the buffer 10 by the data control means 13.

The data configuration shown in FIG. 12(c) is a data storage configuration of the buffer 10 after the link block 2 as a second block is read out, from the data configuration of the buffer 10 shown in FIG. 12(b). Similarly to the case where the link block 1 as the first block is read out, the data control means 13 re-writes the link block 2 from the format shown in FIG. 11(a) to the format shown in FIG. 11(b) on the basis of the judgment result which is obtained by the user block judging means 7 that the link block 2 is a link block. The R/W control means 9 writes data into the buffer 10 with referring to the address pointer that is obtained by the address pointer generating means 8.

As a result, as shown in the data configuration shown in FIG. 12(c), the buffer 10 becomes a state where the data of link block 1, link block 2 are written in into. The link block 1, link block 2 are re-written into the format shown in FIG. 11(b) by the data control means 13 and stored in the buffer.

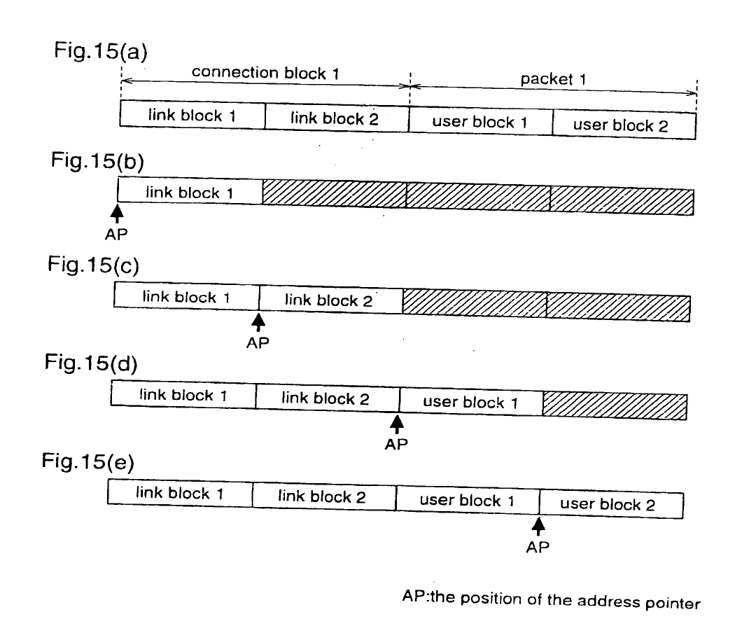

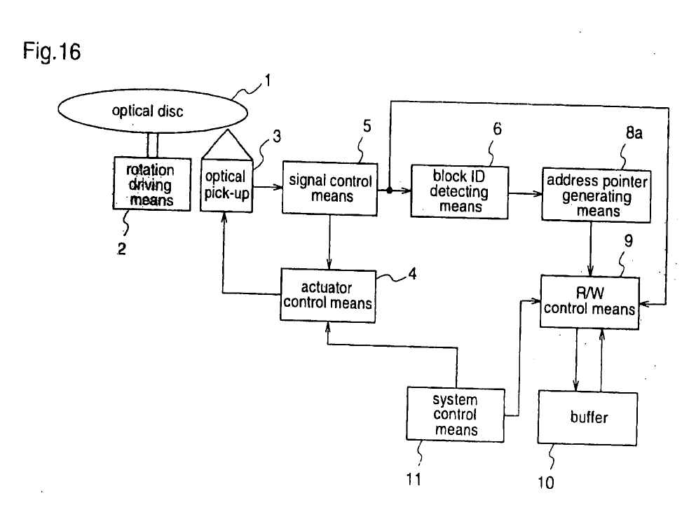

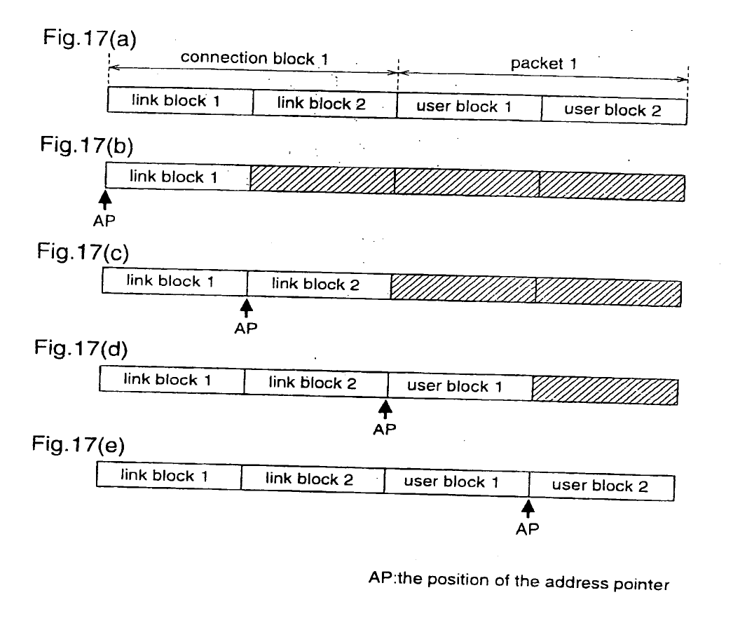

The data configuration shown in FIG. 12(d) is a data storing configuration of the buffer 10 after the user block 1 as the third block is read out, from the data storing configuration of the buffer 10 shown in FIG. 15(c). The user block 1 which is read out is judged as necessary user blocks by the user block judging means 7. When the user block 1 is judged as a user block by the user block judging means 7, the data control section 13 does not carry out any control, and the data read out from the disc 1 is as it is written in into the buffer 10 with referring to the address pointer which was obtained by the address pointer generating means 8.

As a result, as shown in the data configuration shown in FIG. 12(d), the buffer 10 becomes a state where the data of link block 1, link block 2, and user block 1 are written in into. The link block 1, link block 2 are re-written into the format shown in FIG. 11(b) by the data control means 13 and stored in the buffer, and the user block 1 is stored in the buffer 10 as in the format of FIG. 11(a).

The data configuration shown in FIG. 12(e) is a data storage configuration of the buffer 10 after the link block 2 as a fourth block is read out, from the data storage configuration of the buffer 10 shown in FIG. 12(d). Similarly as in the case where the user block 1 as the third block is read out, on the basis of the judgment result that the user block 2 is a user block, that is obtained by the user block judging means 7, the data control means 13 does not carry out any control, and the data which was read out from the disc 1 is as it is written into the buffer 10 with referring to the address pointer that is obtained by the address pointer generating means 8.

As a result, as shown in the data configuration shown in FIG. 12(e), the buffer 10 becomes a state where the data of link block 1, link block 2, user block 1, user block 2 are written in into. The link block 1, link block 2 are re-written into the format shown in FIG. 11(b) by the data control means 13 and stored in the buffer 10 and the user block 1 and the user block 2 are stored in the buffer 10 as in the format shown in FIG. 11(a).

As described above, according to a signal processing circuit of the sixth embodiment, since there are provided the user block judging means 7 and the data control means 13, and when it is judged that the data which was read out by the recording medium 1 is link block, the data is stored in the buffer 10 with its format re-written by the data control means 13, unnecessary link blocks are stored in the buffer in their distinguishable state, and thereby, unnecessary link blocks can be easily judged when outputting the data in the buffer 10, and taking out of only user blocks can be realized easily.

While in the above sixth embodiment, a case where a control is carried out such that 8 bytes in which 0 data in the Auxiliary data in one sub-coding frame of a CD-ROM are replaced by one data as a distinction information is described, any data among the one sub-coding frame of a CD-ROM (such as header section or User data section) may be replaced to identifiable data as distinction information with the same effects being obtained.

Further, if it can be judged as a distinction information, the data may be replaced in whatever manner with the same effects being obtained.

Further, in the above-described sixth embodiment, the mode 1 format of CD-ROM is described, other modes may be utilized with the same effects being obtained.

### EMBODIMENT 7

Next, a signal processing circuit according to a seventh embodiment of the present invention will be described.

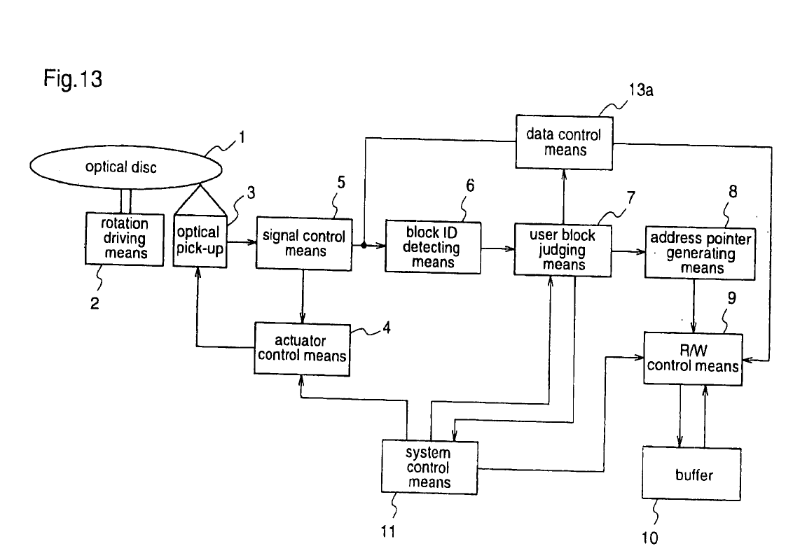

FIG. 13 is a diagram illustrating a block construction of an optical disc apparatus having a signal processing circuit according to the seventh embodiment of the present invention.

In FIG. 13, numeral 1 denotes an optical disc (recording medium) in which information signal is recorded on spiral or concentric tracks. Numeral 2 denotes a rotation driving means which rotates the optical disc 1. Numeral 3 denotes an optical pick-up which irradiates light beam onto the information surface of the optical disc 1 and detects its reflected light, to output various information. Numeral 4 denotes an actuator control means for moving the optical pick-up 3 in the focusing direction and in the radius direction so as to read out the information in the optical disc 1. Numeral 5 denotes a signal control means for receiving the signal obtained from the optical disc 1 and takes out the signal for controlling the-actuator and the information signal. Numeral 6 denotes a means for detecting the block ID from the signal control means. Numeral 7 denotes user block judging means for carrying out user block judgment from the information from the block ID detection means 6 and the information from the block ID information corresponding to the user block. Numeral 8 denotes an address generating means for generating an address pointer to the buffer 10.

Further, numeral 9 denotes an R/W control means for controlling the writing in or reading out in or from the buffer 10. Numeral 11 denotes a system control means which instructs the reading out position against the actuator control means 4 as well as instructs the user block ID against the user block judging means 7, and further instructs the writing in or reading out to the R/W control means 9.

Further, numeral 13adenotes data control means for adding the distinction information to the data to be stored in the receiving buffer 10 from the signal control means 5 on the basis of the judgment result by the user block judging means 7.

An operation of the optical disc apparatus constituted as above will described with referring to FIGS. 13, 14, and 15.

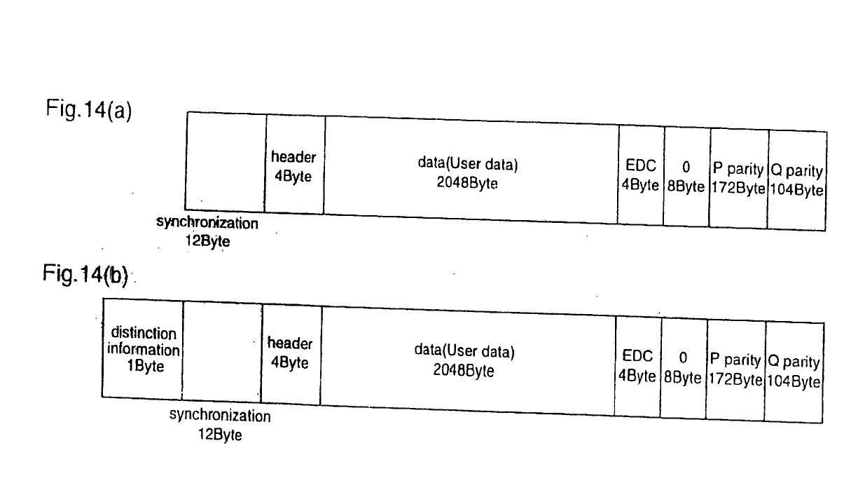

FIG. 14 shows a data format of an optical disc provided with a signal processing circuit according to a seventh embodiment of the present invention, and shows a format of one sub-coding frame in mode 1 of a CD-ROM. FIG. 14 (a) shows a data format which was read out from disc l, and FIG. 14(b) shows a data format after it is controlled such that 1 byte distinction information is added by the data control means 13a. Here, the data control section 13aadds, as 1 byte distinction information, one which can distinguish the user block and the link block to each other.

FIG. 15 shows a data format in an optical disc provided with a signal processing circuit according to the seventh embodiment of the present invention. Further, the arrows shown in the figure show the position (AP) of the address pointer which is obtained by the address pointer generating means 8.

The data configuration in FIG. 15(a) schematically shows the information signal which is written on a disc 1 for each block. It is supposed that on the disc 1, blocks at the link section are written in into the connection blocks by two blocks (hereinafter, referred as link block 1, link block 2), and user blocks are written in into the packet by two blocks (hereinafter, referred to as user block 1, user block 2) continuously to each other, as shown in the data configuration in FIG. 15(a). Further, the packets and the connection blocks are respectively alternatively constituted on a disc as packet 1, connection block 1, packet 2, connection block 2, . . . .

The data configuration shown in FIG. 15(b) is a data storage configuration in the buffer 10 after the link block 1 as the first block is read out. First of all, the user block judging information (herein, the user block 1, and user block 2) to be an objective is instructed to the user block judging means 7 by the system control means 11, and further, it is instructed to the R/W control means 9 to write the read data into the buffer 10. Meanwhile, the data control means 13aadds, to the link block 1 in the format shown in FIG. 14(a), “1” data of 1 byte to the header section as a distinction information of a link block, as the format shown in FIG. 14(b) on the basis of the judgement result that the read out link block 1 is a link block that is obtained by the user block judging means 7. Further, the R/W control means 9 writes data into the buffer 10 with referring to the address pointer which is obtained by the address pointer generating means 8.

As a result, the data of link block 1 is written in into the buffer 10, as shown in the data configuration in FIG. 15(b). Further, the data of the link block 1 to which “1” data of 1 byte is added as a distinction information of a link block in the format of FIG. 14(b) is stored in the buffer 10 by the data control means 13a.

The data configuration shown in FIG. 15(c) is a data configuration of the buffer 10 after the link block 2 as a second block is read out, from the data storage configuration of the buffer 10 shown in FIG. 15(b). Similarly to the case where the link block 1 as the first block is read out, the data control means 13aadds, to the link block 2 of the format shown in FIG. 14(a), “1” data of 1 byte to the header section thereof as a distinction information of a link block, as in the format shown in FIG. 14(b), on the basis of the judgment result that the read out link block 2 is a link block that is obtained by the user block judging means 7. The R/W control means 9 writes data into the buffer 10 with referring to the address pointer that is obtained by the address pointer generating means 8.

As a result, as shown in the data configuration shown in FIG. 15(c), the buffer 10 becomes a state where the data of link block 1, link block 2 are written in into. The link block 1, link block 2 are written into the buffer 10, as data to which “1” data of 1 byte is added thereto as a distinction information for a link block, in the format shown in FIG. 14(b), respectively.

The data configuration shown in FIG. 15(d) is a data storing configuration of the buffer 10 after the user block 1 as the third block is read out, from the data storing configuration of the buffer 10 shown in FIG. 15(c). The user block 1 which is read out is judged as necessary user blocks by the user block judging means 7. When the user block 1 is judged as a user block by the user block judging means 7, “0” data of 1 byte is added to the header section as a distinction information for the user block in the format shown in FIG. 14(b) by the data control means 13ato the user block 1 in the format shown in FIG. 14(a). The R/W control means 9 writes a data into the buffer 10 with referring to the address pointer which is obtained by the address pointer generating means.

As a result, as shown in the data configuration shown in FIG. 15(d), the buffer 10 becomes a state where the data of link block 1, link block 2, user block 1 are written into. The link block 1, link block 2 are stored in the buffer 10 as data in which “1” data of 1 byte is added thereto as a distinction information for the user block in the format shown in FIG. 14(b), respectively, and the user block is stored in the buffer 10, as data in which “0” data of 1 byte is added as a distinction information for the user block, in the format shown in FIG. 14 (b).

The data configuration shown in FIG. 15(e) is a data storage configuration of the buffer 10 after the link block 2 as a fourth block is read out, from the data storage configuration of the buffer 10 shown in FIG. 15(d). Similarly as in the case where the user block 1 as the third block is read out, on the basis of the judgment result that the read out user block 2 is a user block, that is obtained by the user block judging means 7, the data control means 13a adds, to the user block 2 of the format shown in FIG. 14(a), “0” data of 1 byte to the header section thereof as a distinction information of a user block as shown in the format shown in FIG. 14(b). The R/W control means 9 writes the data into the buffer 10 with referring to the address pointer that is obtained by the address pointer generating means 8.

As a result, as shown in the data configuration shown in FIG. 15(e), the buffer 10 becomes a state where the data of link block 1, link block 2, user block 1, user block 2 are written in into. The link block 1, link block 2 are written into the buffer 10 as data in which “1” data of 1 byte is added as a distinction information for the link block in the format shown in FIG. 14(b), and the user block 1 and the user block 2 are written into buffer 10 as data in which “0” data is added as a distinction information for a user block in the format shown in FIG. 14(b).

As described above, according to the signal processing circuit of the seventh embodiment, there are provided the user block judging means 7 and the data control means 13a, and when the data that is read out from the recording medium 1 is a link block, the data is stored in the buffer 10 with “1” data of 1 byte being added thereto as a distinction information for a link block, while when it is user data, the data is stored in the buffer 10 with “0” data of 1 byte being added thereto as a distinction information for a user block. Therefore, the buffer is in a state in which necessary user blocks and unnecessary link blocks can be judged for their blocks by the added 1 byte distinction information, and therefore, when the data in the buffer 10 is to be outputted, unnecessary link blocks can be easily judged and taking out of only the user blocks can be easily realized.

While in the above seventh embodiment, a control that a distinction information of 1 byte is added to the header section of the 1 sub-coding frame of a CD-ROM is carried out, the bit width of the distinction information or data may be any type one with the similar effects being obtained.

Further, the position where the distinction information is to be added may be anywhere with the same effects being obtained.

Further, in the above-described seventh embodiment, the mode 1 format of CD-ROM is described, other modes may be utilized with the same effects being obtained.

While in the above-described first to seventh embodiments, the signal processing circuit is constituted by a hardware, this portion may be constituted by software.

Further, while in the first to seventh embodiments, a recording medium is described as one which is utilized in an optical disc apparatus, a disc apparatus which employs an optical magnetic disc, or a magnetic disc may be employed with the same effects obtained

### APPLICABILITY IN INDUSTRY

The signal processing circuit of the present invention has an effect of efficiently reading out data from a disc which data are written in onto the tracks on a disc such as CD-ROM, CD-R, CD-RW with divided into plural packets, and it is useful as a circuit for incorporating the same into such as an optical disc apparatus.

Further, it is not limited to an optical disc but can be applicable to uses such as an optical magnetic disc and a magnetic disc.

1. A signal processing circuit comprising:
data reading out means for reading out data comprising user blocks in the packet and/or link blocks in the connection blocks;
a buffer for successively storing the data which are read out;
user block judging means for judging as to whether the read out data are desired user blocks or not;
address pointer generating means for generating an address pointer on the basis of the judgment result from the user block judging means; and
system control means for controlling to maintain the position of the address pointer at a position in the buffer where the link block is written in prior and to overwrite the data which were read out this time onto the data of link block which are previously written in into the buffer.

2. A signal processing circuit as defined in claim 1, wherein
there is provided block ID detecting means which detects the block ID while successively reading out the data.

3. A signal processing circuit as defined in claim 2, wherein
there is provided continuity judging means which defines continuity of blocks on the basis of the block ID.

4. A signal processing circuit as defined in claim 2, wherein
the user block judging means compares the link block ID under being read out and the top block ID, thereby to judge that the block under being read out is a link block until the top block ID of the user block is detected, or compares the user block under being read out and the top block ID of the link block, thereby to judge that the block under being read out is a user block until the top block ID of the link block is detected.

5. A signal processing circuit as defined in claim 3, wherein
the system control means conducts, when it is detected that the block ID is a link block ID in the same connection block or a top block of a desired user block ID when the discontinuity of the block ID is detected by the continuity judging means, a control such that a re-search of a block is not conducted but the reading out of the data conducted as it is.

6. A signal processing circuit as defined in claim 5, wherein:
the system control means judges the direction of discontinuity of the block ID by comparing the block ID and the block ID immediately before that when the discontinuity of the block ID is detected by the discontinuity judging means, and it is controlled that when the position of the data reading out position has moved to the direction coming close to a desired user block, re-search of a block is not conducted, while when the reading out position of data has moved to the direction different from that coming close to the desired position, or when the block ID and the block ID immediate before the block ID are identical to each other, the re-search of the block is conducted.

7. A signal processing circuit comprising:
data reading out means for reading out data comprising user blocks in the packet and/or link blocks in the connection blocks;
a buffer for successively storing data which are read out;
user block judging means for judging as to whether the read out data are desired user blocks or not; and
data control means for controlling so that the data is converted in its data format and is stored in the buffer.

8. A signal processing circuit comprising:
data reading out means for reading out data comprising user blocks in the packet and link blocks in the connection blocks, which are stored on tracks formed on an optical disc;
a buffer for successively storing the data which are read out;
user block judging means for judging as to whether the read out data are desired user blocks or not; and
data control means for controlling a distinction information with being added to the data is stored in the buffer, which distinction information which can distinguish whether the data read out as above is user block or a link block on the basis of the judgment result by the user block judging means.
